(19) United States
(12) Patent Application Publication
(10) Pub. No.: US 2007/0215045 A1
(43) Pub. Date: Sep. 20, 2007

(54) COATING FILM FORMING APPARATUS

(76) Inventors: Michitaka HIGAKI, Atsugi-shi (JP); Takayuki Yoshii, Yokohama-shi (JP); Yasuomi Mikami, Chigasaki-shi (JP); Kentaroh Yajima, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/687,351

(22) Filed: Mar. 16, 2007

(30) Foreign Application Priority Data
Mar. 17, 2006 (JP) 2006-074765

(51) Int. Cl. B05B 3/00; B05C 11/00

(52) U.S. Cl. 118/680; 118/679; 118/323

(57) ABSTRACT

The present invention is directed to a coating film forming apparatus 1. The apparatus 1 includes a coating unit 11, a coating material supply unit 10, and a control unit 12. The coating unit 11 contains a holding unit 18 for holding a substrate 4, a coating nozzle 19, and a movable unit 20. The coating nozzle 19 is provided with a slit for discharge coating material to an inner circumferential surface, formed in annular shape. The movable unit 20 moves the coating nozzle 19 along a shaft center P of the substrate 4. The control unit 12 controls to apply coating material 7 to an outer circumferential surface 4c of the substrate 4 from a lower end 4a upward in order.

### PRIORITY CLAIM

This application claims priority from Japanese Patent Application No. 2006-074765, filed with the Japanese Patent Office on Mar. 17, 2006, the contents of which are incorporated herein by reference in its entirety.

### BACKGROUND OF THE INVENTION

1. Field of the Invention

The present invention relates to a coating film forming apparatus that forms a coating film by applying coating to an outer circumferential surface having a cylindrical surface, and particularly to a coating film forming apparatus appropriate in forming an elastic layer of a fixing member (a fixing roll and/or fixing belt) that fixes an unfixed toner image on a transfer paper by heating and/or pressing, for example, in an image forming apparatus employing an electronic photographic system such as a PPC (a plain paper copier), a LBP (a laser beam printer), and a facsimile.

2. Description of the Related Art

An image forming apparatus such as a copying machine and a printer, which are based on the principle of electro-photography, performs a fixing process in which a transfer sheet is made narrower and thicker and toner is resolved by heat to transfer to the sheet. Recent years, an elastic layer, which consists of heat resistant rubber such as silicon rubber, has been formed in parts (a fixing roll or fixing belt) used in the fixing process. The fixing roll or fixing belt can be obtained as follows. A primer (an adhesive) is applied on the substrate (cylindrical core metal made up of metal such as aluminum or iron, or belt-shape substrate consisting of polyimide or Ni) and a coating material including heat-resistant rubber such as silicon rubber is applied to form an elastic layer having approximately a thickness of 100 to 300 μm. Then, as mentioned above, the fixing roll or fixing belt can be obtained.

It is generally known that the aforementioned elastic layer makes constant a pressure for pressing toner on a transfer paper in fixing and improves the degree of particle of an image. The thickness of the elastic layer affects an image and a rise time of a fixing roll (time to reach a predetermined temperature) because of the thermal conductivity of heat-resistant rubber. Therefore, it is sought that the thickness of the elastic layer be uniform.

Various kinds of coating film forming apparatus have been used in the past in order to form the above-mentioned elastic layer. See, for example, Japanese Patent Publication No. 2005-87955. The Publication discloses a coating film forming apparatus that forms the elastic layer as follows. The coating film forming apparatus locates the above-described substrate so that a shaft center is horizontal. After a blade-like coating nozzle discharges coating material that has stuck to the substrate, the coating material is discharged from the nozzle by rotating the substrate. This is how the elastic layer is formed.

The coating film forming apparatus of the Publication discharges the coating material from the blade-like coating nozzle by rotating the substrate to form the coating film on the outer circumferential face of the substrate. Accordingly, when the coating film formed first by one rotation after the substrate begins to be coated overlaps the coating film formed last, there is produced a step, i.e., a difference, between the coating films. Because of this, when the aforementioned coating film forming apparatus is used, the coating material is applied to form coating film. Then, a mechanical process such as a grinding process on the outer surface of the coating film is given to keep constant the thickness of the coating film.

In this way, the conventional coating film forming apparatus produces a step in the formed coating film. This necessitates a mechanical process after the coating material is applied, which increases the number of processes required to form a uniform thickness on the outer circumferential surface of the substrate.

For the foregoing reasons, there is a need for a coating film forming apparatus that can form a uniform thickness of a coating film.

### SUMMARY OF THE INVENTION

The present invention is directed to a coating film forming apparatus that satisfies this need. The apparatus is for forming a coating film by applying a coating material on an outer circumferential surface of an intended-to-be-coated cylindrical object having a shaft center, a lower end and an upper end. The apparatus comprises a holding unit for holding the object in a condition in which the outer circumferential surface is exposed and the shaft center is in a vertical direction; a annular coating nozzle having an inner circumferential surface opposite to the outer circumferential surface of the object with a space therebetween, placed to be coaxial with the object, the inner circumferential surface having slits for discharging the coating material along an entire circumference thereof; a movable unit for relatively moving the holding unit and the coating nozzle along the shaft center; a coating material supply unit for supplying the coating material to the coating nozzle; and a control unit for controlling the movable unit and the coating material supply unit so that the coating material is discharged from the slits of the coating nozzle opposite to the lower end of the object and the coating nozzle is moved to the upper end of the object while discharging the coating material from the slits.

Advantageously, the space CG between the outer circumferential surface of the object and the inner circumferential surface of the coating nozzle satisfies the following equation:

(3/2)T≦CG≦(1/250)(T²−340T+312)

where the symbol T represents a thickness of the coating film.

Advantageously, the control unit controls the movable unit and the coating material supply unit, so that the coating nozzle moves toward the upper end after the coating material discharged from the slits of the coating nozzle, which has stopped opposite to the lower end of the object, has attached to the outer circumferential surface of the object.

Advantageously, the control unit controls the movable unit and the coating material supply unit, so that the coating nozzle moves toward the upper end once again after the discharging of the coating material from the slits of the coating nozzle on the rise is stopped and the movement of the coating nozzle to the upper end has been stopped once with the coating material transferred from the slits to the outer circumferential surface of the object.

### BRIEF DESCRIPTION OF THE DRAWINGS

These and other features, aspects, and advantages of the present invention will become better understood with regard to the following description, appended claims, and accompanying drawings.

FIG. 1 is a schematic view showing a structure of a coating film forming apparatus in accordance with a first embodiment of the invention.

FIG. 2 is a cross sectional view of a coating nozzle taken along line II-II of the coating film forming apparatus shown in FIG. 1.

FIG. 3 is a flowchart showing a series steps of coating film forming by the coating film forming apparatus shown in FIG. 1.

FIG. 4 is a cross sectional view showing a situation where a coating nozzle opposite to the lower end of a substrate stops its function at step S3 of FIG. 3.

FIG. 5 is a cross sectional view showing a situation where coating material from the coating nozzle has stuck to an outer circumferential surface of a substrate.

FIG. 6 is a cross sectional view showing a situation where the coating nozzle of FIG. 5 is rising.

FIG. 7 is a cross sectional view showing a situation where the coating nozzle of FIG. 6 has temporarily stopped opposite to the upper end of a substrate.

FIG. 8 is a cross sectional view showing a situation where the coating nozzle of FIG. 7 has risen once again.

FIG. 9 is a cross sectional view showing a situation where coating material has stuck to the upper end of the substrate of FIG. 8.

FIG. 10 is an illustrative view for explaining the relationship between a position for stopping a substrate and a position for stopping a coating nozzle held in the coating film forming apparatus shown in FIG. 1.

FIG. 11 is a perspective view of a fixing belt in which a coating film is formed by the coating film forming apparatus shown in FIG. 1.

FIG. 12 is a cross sectional view taken along line XII-XII of FIG. 11.

FIG. 13 is an illustrative view for showing the relationship of the space between a coating nozzle and a substrate, with respect to the thickness of a coating film of the coating film forming apparatus shown in FIG. 1.

### DETAILED DESCRIPTION OF THE INVENTION

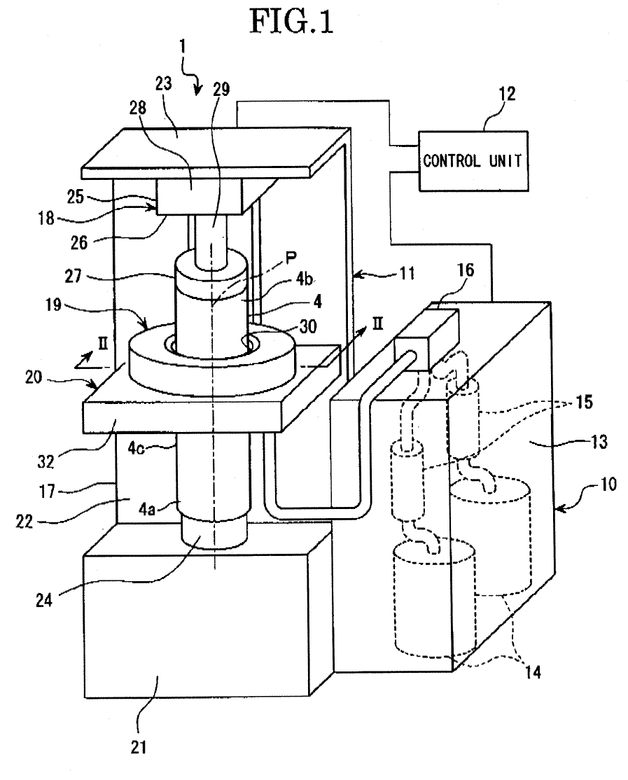

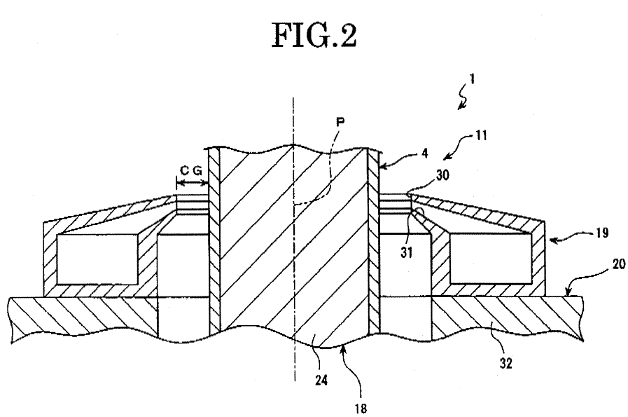

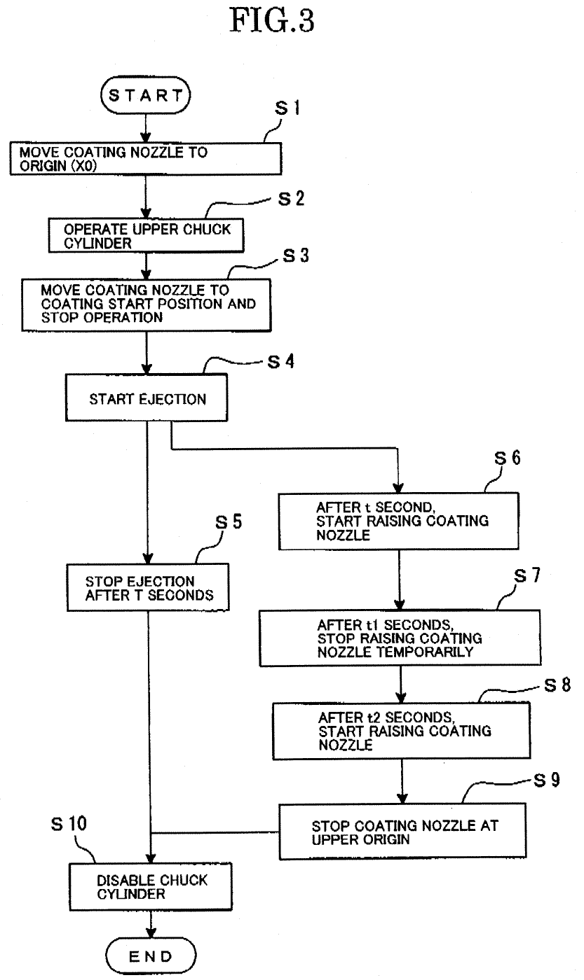

One embodiment of the present invention will be described hereinafter, referring to FIGS. 1-12. FIG. 1 is a diagram showing a structure of one embodiment of a coating film forming apparatus in accordance with the present invention. FIG. 2 is a cross sectional diagram of a coating nozzle taken along line II-II of the coating film forming apparatus shown in FIG. 1. FIG. 3 is a flowchart for showing a series steps of coating film forming for the coating film forming apparatus shown in FIG. 1.

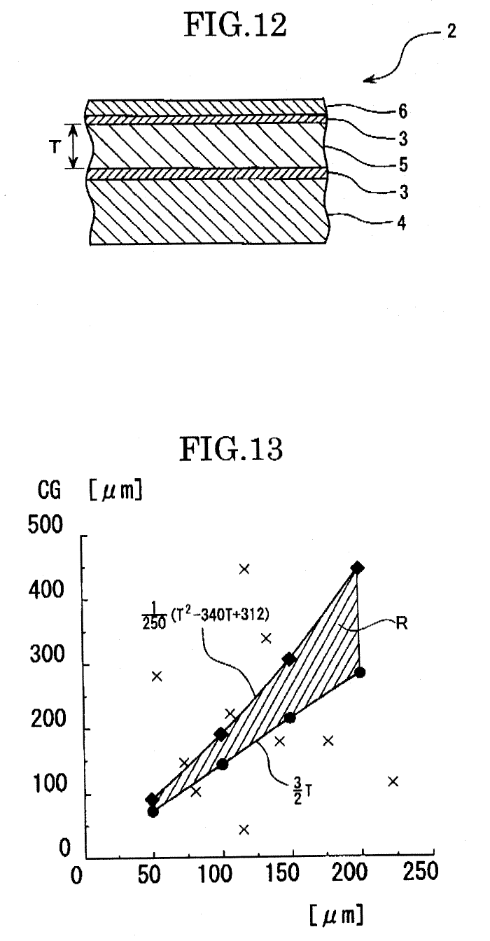

The coating film forming apparatus forms an elastic layer 5 as a coating film on a substrate 4 as a cylindrical object that is intended to be coated, on which a primer layer 3 (see FIG. 12) of a fixing belt 2 (see FIG. 11) is formed, when the fuse belt 2 constitutes an image forming apparatus such as a copying machine.

The fixing belt 2, as shown in FIG. 11, is formed to have no end. The fixing belt 2, as shown in FIG. 12, is piled up in order to include an endless belt type of substrate 4 consisting of polyimide or Ni, the primer layer (adhesive) 3, the elastic layer 5 consisting of beat-resistant rubber such as silicon rubber, the primer layer (adhesive) 3, and a mold release layer 6 composed of fluorine resin. The thickness T of the elastic layer 5 ranges approximately from 100 to 300 μm.

The elastic layer 5 includes one end 4a (a lower end where the coating film forming apparatus 1 applies a coating material 7) in the width direction of the substrate 4, and the other end 4b (an upper end where the coating film forming apparatus 1 applies a coating material 7) in the width direction of the substrate 4. The fixing belt 2 is heated and presses toner against a transfer sheet to fix the toner on the transfer sheet.

The coating film forming apparatus 1 applies coating material 7, including the silicon rubber and well-known solvent, to the outer surface of the substrate 4 (also called “coated member”), i.e., the primer (adhesive) layer 3 to form the elastic layer 5. The coating material 7 has a viscosity μ that satisfies the following Equation Eq. 1. That is, the viscosity of the coating material 7 is sufficiently larger than that of the coating material used to form the primer layer 3 and mold release layer 6.

10 [Pa·s]≦μ100 [Pa·s] (1)

The coating film forming apparatus 1, as shown in FIG. 1, includes a coating material supply unit 10 for supplying coating material, a coating unit 11, and a control unit 12. The coating material supply unit 10 contains a unit body 13 placed on the floor of a factory, a plurality of undiluted solution tanks 14, a plurality of sucking pumps 15, and a mixer 16. The undiluted solution tanks 14, the sucking pumps 15, the mixer 16, and the coating nozzle 19 of the coating unit 11 are mutually interconnected by, for example, a duct.

The unit body 13 is formed to be box-shaped. The undiluted solution tanks 14 and the sucking pumps 15 are contained in the unit body 13. The undiluted solution tanks 14 include liquid from which the coating material 7 is derived. There are provided two undiluted solution tanks 14 in the figure. The sucking pumps 15 suck up the liquid in the undiluted solution tanks 14 to be provided to the mixer 16. One sucking pump 15 is provided for one undiluted solution tank 14. The mixer 16 is arranged on the upper surface of the unit body 13, and receives the liquid that is sucked up by the undiluted solution tanks 14 and is furnished by the sucking pumps 15. The mixer 16 mixes the liquids from a plurality of undiluted solution tanks 14 to create the coating material 7. The coating material 7 is sent out to the coating nozzle 19.

The coating unit 11 includes a unit body 17, a holding unit 18, a coating nozzle 19, and a movable unit 20. The unit body 17 contains a base 21 that is supposed to be placed, for example, on the floor of a factory, an extension plate 22 extending upward from the base 21, an upper plate 23 extending horizontally from the upper end of the extension plate 22. The upper plate 23 is formed to be flat and is opposed to the base 21 with some space in the vertical direction.

The holding unit 18 contains a pillar 24 and an upper chuck 25. The pillar 24 is column shaped and is standing upward from the upper surface of the base 21. The pillar 24 fixed to the base 21. The shaft center of the pillar 24 is in the vertical direction. The pillar 24 is put through in and holds the substrate 4. When the pillar 24 holds the substrate 4, the outer circumferential surface of the pillar closely touches the inner circumferential surface of the substrate 4. Moreover, when the pillar 24 holds the substrate 4, the shaft center P of the substrate 4 (shown in the broken line in FIG. 1) is vertical, and the outer circumferential face 4c of the substrate 4 constitutes a cylindrical surface (a cross section orthogonal to the shaft center is a circular arc). In this way, the pillar 24, that is, the holding unit 18 holds the substrate 4 with the shaft center P in the vertical direction.

The upper chuck 25 includes a chuck cylinder 26 and a pressing member 27. The chuck cylinder 26 contains a cylinder body 28 and a rod 29 connected to the cylinder body 28 The cylinder body 28 is mounted to the upper plate 23 so that the rod 29 extends downward in the vertical direction. The pressing member 27, formed to be a thick disc, is mounted to the top of the rod 29 and is disposed to have a common shaft with the pillar 24.

When the rod 29 of the chuck cylinder 26 is extended, the pressing member 27 interferes with (touches) the upper end 4b of the substrate 4 held by the pillar 24 to position the substrate 4 with respect to the pillar 24. On the other hand, when the rod 29 of the chuck cylinder 26 is shortened, the pressing member 27 gets away from the pillar 24 to allow the upper chuck 25 to voluntarily attach the substrate 4 to or detach the substrate 4 from the pillar 24.

The coating nozzle 19, as shown in FIG. 2, is formed to be circular or annular and hollow. The coating material 7 is furnished to the inside of the coating nozzle 19 from the coating material supply unit 10. The coating nozzle 19 is positioned to be coaxial with the pillar 24 and the substrate 4 held by the pillar 24 through the movable unit 20, and is supported to be able to arbitrarily move along the shaft center P.

The inner diameter of the coating nozzle 19 is larger than the outer diameter of the substrate 4 held by the pillar 24. That is, the inner circumferential surface 30 of the coating nozzle 19 is opposite to the outer circumferential surface 4c of the substrate 4 with a space CG and is placed to be coaxial with the substrate 4.

The space CG satisfies the following Eq, 2, where the thickness of the elastic layer 5 to be formed is T.

(3/2)T≦CG≦(1/250)(T²−340T+312) (2)

A slit 31, which communicates with the inside and outside of the coating nozzle 19, is provided along the entire circumference of the coating nozzle 19 in the inner circumferential surface 30. The coating nozzle 19 releases the coating material 7 provided by the coating material supply unit 10, through the slit 31, to the outer circumferential surface 4c of the substrate 4.

The movable unit 20 includes a coating nozzle support plate 32, a linear guide, a motor, a linear encoder, etc. The coating nozzle support plate 32 is made circular and has the coating nozzle 19 on the surface thereof. Moreover, the coating nozzle support plate 32 is placed between the base 21 and the upper plate 23 with the pillar 24 therethrough. The linear guide supports the coating nozzle support plate 32, i.e., the coating nozzle 19 so that the coating nozzle 19 can move freely move in the vertical direction. The motor moves the coating nozzle support plate 32, i.e., the coating nozzle 19 in the vertical direction. That is, the motor raises or lowers the coating nozzle support plate 32 or the coating nozzle 19.

The linear encoder detects the position of the coating nozzle support plate 32 or the coating nozzle 19 to output the detected position to the control unit 12. In this way, the movable unit 20 relatively moves the substrate 4 and the coating nozzle 19 along the shaft center P of the substrate 4, by raising or lowering the coating nozzle support plate 32.

The control unit 12 is a computer that includes a well-known RAM, ROM, CPU, etc, and is connected to the coating material supply unit 10 and the coating unit 11 to control an overall operation of the coating film forming apparatus 1 through controlling these units. Namely, the control unit 12 receives information from the linear encoder of the movable unit 20, and based on the information concerning the position of the coating nozzle 19 from the encoder, controls the operation of the chuck cylinder 26, the motor of the movable unit 20, and the mixer 16 of the coating material supply unit 10. As a result, the coating material 7 is applied to the outer circumferential surface 4c of the substrate 4 to form the coating film or elastic layer 5.

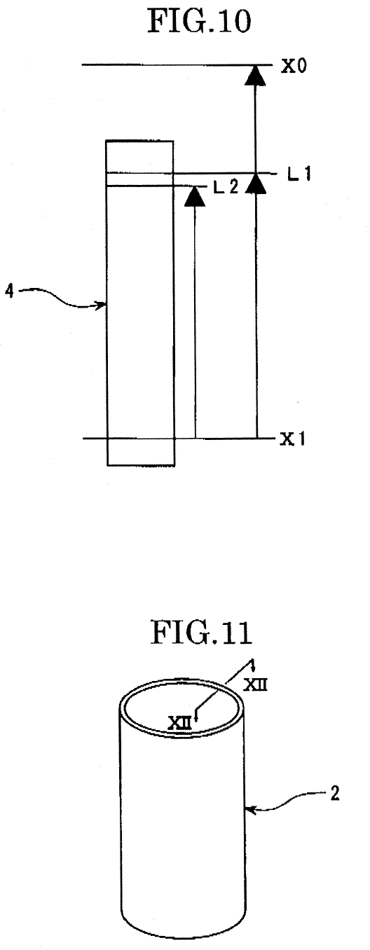

With respect to the coating film forming apparatus 1, in step S1 of FIG. 3, the control unit 12 makes the coating material supply unit 10 stop and the rod 29 of the chuck cylinder 26 shorten. Moreover, the control unit 12 makes the coating nozzle 19 move to the movable unit 20 and put the coating nozzle 19 at an origin (X0) (shown in FIG. 10) more upward than the position of the substrate 4. This concludes step S1 to go to step S2.

At step S2, the pillar 24 is inserted into the substrate 4 which is held at the outer circumference of the pillar 24. When the pillar 24 holds the substrate 4, the control unit 12 makes longer the rod 29 of the chuck cylinder 26. The pressing member 27 disposes the substrate 4. This concludes step S2 to go to step S3.

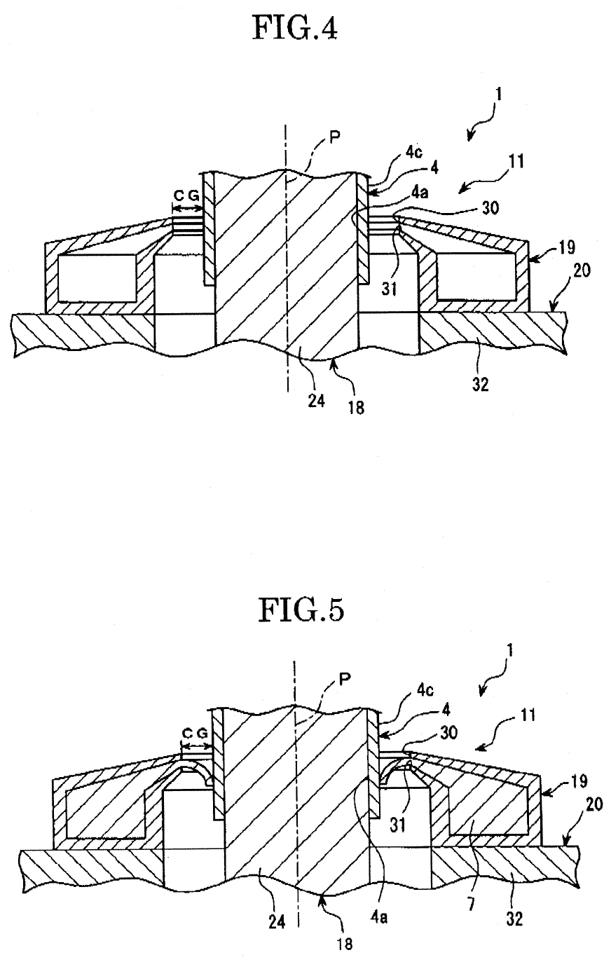

At step S3, the control unit 12 lowers the coating nozzle 19 to the movable unit 20. As shown in FIG. 4, when the inner circumferential surface 30 of the coating nozzle 19 is opposite to the lower end 4a of the substrate 4 and the coating nozzle 19 is placed at a position X1 (shown FIG. 10) that is one to start coating-a coating start position, the control unit 12 stops the operation of the movable unit 20. In this way, after the coating nozzle 19 is placed to be opposite to the lower end 4a of the substrate 4, relative motion of the nozzle 19 with respect to the substrate 4 is stopped. This concludes step S3 to go to step S4.

At step S4, the control unit 12 makes the coating material supply unit 10 furnish the coating material 7 to the coating nozzle 19, and then eject the coating material 7 to the lower end 4a of the substrate 4 from the slit 31 of the coating nozzle 19. This concludes step S4 to go to steps S5 and S6.

At step S6, after “t” seconds have elapsed since ejection of the coating material 7 started (where time “t” seconds is the time from the ejection start to the attachment of the coating material 7 to the lower end 4a of the substrate 4), as shown in FIG. 5, the coating material 7 from the slit 31 attaches to the lower end 4a of the substrate 4. Then, the control unit 12 makes the movable unit 20 raise the coating nozzle 19 with respect to the substrate 4 (namely, moves toward the upper end 4b). The procedure goes to steps S7.

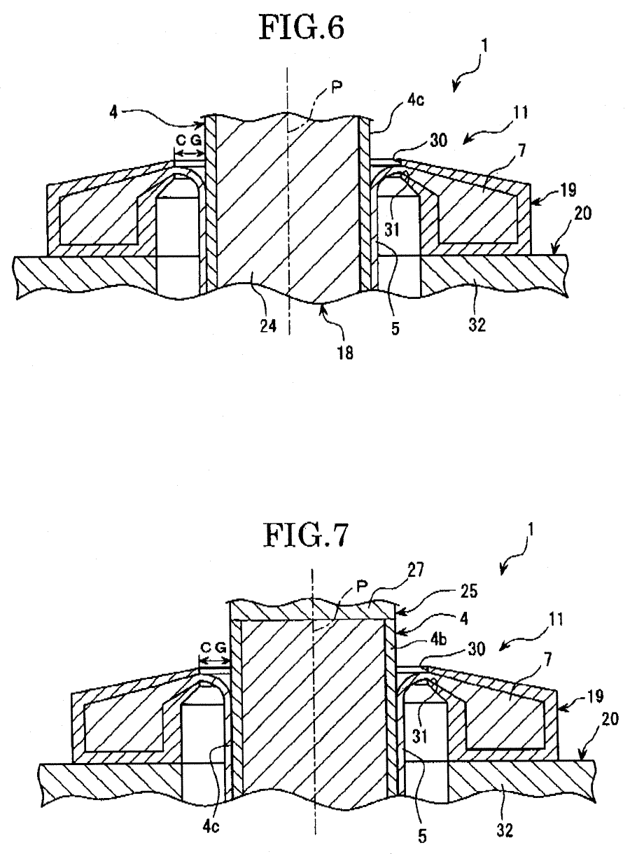

In this way, between step S6 and step S7, as shown in FIG. 6, the coating nozzle 19 is raised, with the coating material 7 discharged from the slit 31.

At step S5, after much longer time “T” than the “t” seconds has elapsed, the slit 31 is placed at a position L2 (shown in FIG. 10) close to the upper end 4b of the substrate 4. When this happens, the control unit 12 makes the coating material supply unit 10 stop supplying the coating material 7. The procedure goes to step S10.

At step S7, after elapse of time “t1” seconds that is longer than both of the “t” seconds and “T” seconds, the slit 31 is positioned at a position L1 (shown FIG. 10) corresponding to the upper end 4b of the substrate 4. As shown in FIG. 7, when the coating material 7 is transferred to the slit 31 and the outer circumferential surface 4c of the substrate 4, the control unit 12 stops the movable unit 20 and temporarily stops raising the coating unit 11 with respect to the substrate 4 (movement to the upper end 4b). The “t1” seconds, in step S7, means the time from the time when operation of the coating material supply unit 10 is stopped to the time when the coating material 7 is transferred to the slit 31 and the outer circumferential surface 4c of the substrate 4. Then, the procedure goes to step S8.

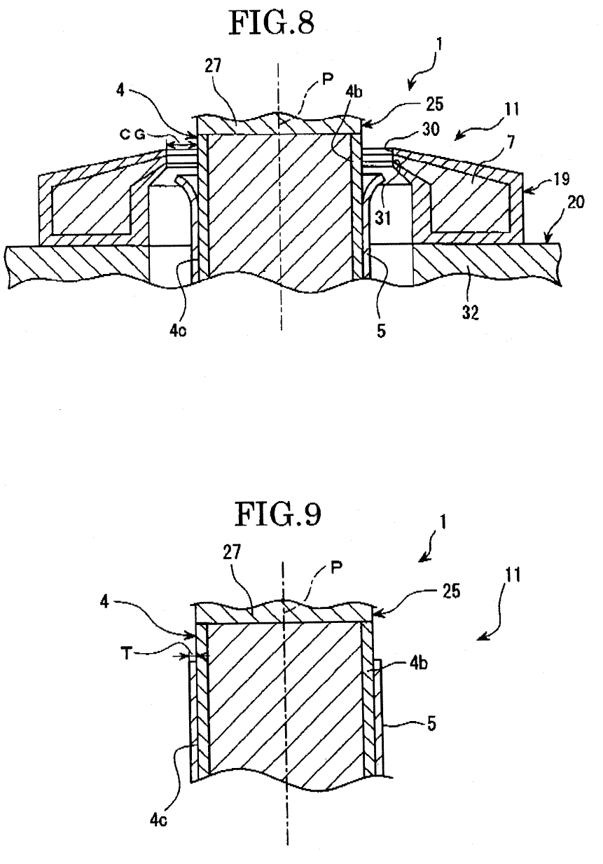

At step S8, after elapse of t2 seconds since the raising of the coating nozzle 19 is stopped temporarily at step S7, the control unit 12 once again makes the movable unit 20 raise the coating nozzle 19 (move toward the upper end 4b) with respect to the substrate 4. Then, as shown in FIG. 8, the coating material 7 is separated from the top of the slit 31, i.e., the inner circumferential surface 30 of the coating nozzle 19. After this, as shown in FIG. 9, the coating material 7 sticks to the outer circumferential surface 4c of the upper end 4b of the substrate 4. Then, the procedure goes to step 9.

At step S9, when the coating nozzle 19 reaches the upper origin X0, the control unit 12 stops the operation of the movable unit 20 to place the coating nozzle 19 at the upper origin X0. In this way, the coating material 7 is applied to the outer circumferential surface 4c of the substrate 4 from the lower end 4a to the upper end 4b, without masking both of the lower end 4a and upper end 4b. Then, for example, after the solvent in the coating material 7 has evaporated, the elastic layer 5 as a thin film is formed on the outer circumferential surface 4c of the substrate 4. The procedure goes to step S10.

At step S10, when the coating nozzle 19 is positioned at the upper origin X0, the control unit 12 shortens the rod 29 of the chuck cylinder 26 to separate the pressing member 27 from the substrate 4. Removing from the pillar 24 the substrate 4 on which the elastic layer 5 is formed, another substrate 4 on which the elastic layer 5 is not formed is attached to the pillar 24. Carrying out the steps mentioned above forms the elastic layer 5.

In this way, the control unit 12 controls the movable unit 20 and the coating material supply unit 10, so that the coating nozzle 19 moves toward the upper end 4b of the substrate 4 while the coating material 7 is ejected from the slit 31 of the coating nozzle 19.

According to the embodiment, the coating nozzle 19 is formed as circular, and the slit 31 for ejecting the coating material 7 is formed all over the entire circumference of the inner circumferential surface 30 of the coating nozzle 19. Accordingly, the coating material 7 can be discharged at a time all over the outer circumferential surface 4c of the substrate 4. Because of this, a step, which is created by overlapping the first formed coating film and the subsequently formed coating film, can be prevented from being produced in the elastic layer 5. Moreover, there is no need to grind the outer surface of the formed coating film, namely, the elastic layer 5. Therefore, this prevents the increase of the required steps such as grinding and enables a uniformly thick coating film, i.e., the elastic layer 5 to be easily formed.

Since the shaft center P holds the substrate 4 in the vertical direction, gravity working on the coating material 7 applied to the outer circumferential surface 4c of the substrate 4 becomes constant in the circumference direction of the substrate 4. This prevents the applied coating material 7 from moving so that the thickness in the circumferential direction after the application varies. Accordingly, it is possible that the thickness of the coating material 7, that is, the elastic layer 5 is maintained to be constant.

Because the elastic layer 5 as a coating film is formed in order from the lower end of the substrate 4 to its upper end, the coating material 7 applied to the substrate 4 moves upward in order. This prevents gas from advancing between the coating material 7 and the substrate 4 because the gas escapes easily upward of the substrate 4. As a result, air bubbles are prevented from being produced in the elastic layer 5 as a coating film, by which the elastic layer 5 as a coating film with high quality can be obtained.

The space CG between the coating nozzle 119 and the substrate 4 is more than one and a half times as large as the thickness T of the elastic layer 5, and is below the value (1/250)*(T²−340T+312). Consequently, because lack of the coating material can be prevented when forming the elastic layer 5, the elastic layer 5 as a coating film having a uniform thickness can be easily formed.

Since the coating nozzle 19 is raised after the coating material 7 ejected by the coating nozzle 19 is attached to the substrate 4, the coating material 7 sticks to the outer circumferential surface 4c of the substrate 4 without interruption. Accordingly, as any steps at the lower end 4a of the substrate 4 are not produced, the elastic layer 5 as a coating film having a uniform thickness can be easily formed.

Since the coating nozzle 19 is raised once again after the movement of the coating nozzle 19 is halted temporarily and the coating material 7 is transferred between the slit 31 and the upper end 4b of the substrate 4, the coating material 7 away from the coating nozzle 19 sticks to the upper end 4b of the substrate 4. Accordingly, as any steps at the upper end 4b of the substrate 4 are not produced, the elastic layer 5 as a coating film having a uniform thickness can be easily formed.

The inventors of the present invention, in the coating film forming apparatus 1 described above, formed the elastic layer 5 on the outer circumferential surface 4c of the substrate 4, by varying the thickness T of the elastic layer 5 and the space CG between the coating nozzle 19 and the outer circumferential surface 4c of the substrate 4. The results are shown in FIG. 13. The legend x in FIG. 13 shows the cases where the outer surface was not able to form the flat elastic layer 5 because a step is created on the outer surface of the elastic layer 5. The black squares and black circles in FIG. 13 show a boundary between a case where the outer surface could form the flat elastic layer 5 and a case where the outer surface could not form the flat elastic layer 5.

The lines that connect a black square to a black square and a black circle to a black circle (called “approximate equation” or “regression line”) were obtained by the least square method, and then the region R (shown by parallel lines in FIG. 13) for showing the relationship between the thickness T and the space CG, in which the outer surface could form the flat elastic layer 5, was also obtained. The region R is a region in which the outer surface was able to form the flat elastic layer 5 with no step created on the outer surface. That is, it has become apparent that where the following Eqs. 3 and 4 hold for the space CG and the thickness T, the outer surface is able to form the flat elastic layer 5 with no step created on the outer surface.

(3/2)T=CG (3)

CG=(1/250)(T²−340T+312) (4)

The aforementioned embodiment shows a case where the elastic layer 5 in the fixing belt 2 is formed. However, the present invention is not limited to the fixing belt 2, and can be applied to various kinds of endless belts in which a coating film is formed. Moreover, the aforementioned embodiment represents an example of an endless belt-shaped fixing belt 2; however, the present invention can be applied to a fixing roll that can be obtained by forming a coating material after the coating material 7 is applied to the outer circumferential surface of the core metal of the roll as a cylindrical coated object composed of metal.

In the aforementioned embodiment, the coating nozzle 19 is moved, with the substrate 4 fixed. However, according to the present invention, the substrate 4 may be moved with the coating nozzle 19 fixed, or both the substrate 4 and the coating nozzle 19 may be moved.

While preferred embodiment of the invention have been described and illustrated above, it should be understood that this is exemplary of the invention and are not to be considered as limiting. Additions, omissions, substitutions, and other modifications can be made without departing from the substance of the present invention. Accordingly, the invention is not to be considered as being limited by the foregoing description, and is only limited by the scope of the appended claims.

What is claimed is:

1. A coating film forming apparatus (1) for forming a coating film by applying a coating material on an outer circumferential surface (4c) of an intended-to-be-coated cylindrical object (4) having a shaft center (P), a lower end and an upper end, the apparatus comprising:
a holding unit (18) for holding the object (4) in a condition in which the outer circumferential surface (4c) is exposed and the shaft center (P) is in a vertical direction;
a annular coating nozzle (19) having an inner circumferential surface opposite to the outer circumferential surface (4c) of the object (4) with a space therebetween, placed to be coaxial with the object (4), the inner circumferential surface having slits (31) for discharging the coating material along an entire circumference thereof;
a movable unit (20) for relatively moving the holding unit (18) and the coating nozzle (19) along the shaft center (P);
a coating material supply unit (10) for supplying the coating material to the coating nozzle (19); and
a control unit (12) for controlling the movable unit (20) and the coating material supply unit (10) so that the coating material is discharged from the slits (31) of the coating nozzle (19) opposite to the lower end (4a) of the object (4) and the coating nozzle (19) is moved to the upper end (4b) of the object (4) while discharging the coating material from the slits (31).

2. A coating film forming apparatus as recited in claim 1, wherein the space CG between the outer circumferential surface of the object and the inner circumferential surface of the coating nozzle satisfies the following equation:
(3/2)T≦CG≦(1/250)(T²−340T+312)
where the symbol T represents a thickness of the coating film.

3. A coating film forming apparatus as recited in claim 1 or 2, wherein the control unit controls the movable unit and the coating material supply unit, so that the coating nozzle moves toward the upper end after the coating material discharged from the slits of the coating nozzle, which has stopped opposite to the lower end or the object, has attached to the outer circumferential surface of the object.

4. A coating film forming apparatus as recited in claim 3, wherein the control unit controls the movable unit and the coating material supply unit, so that the coating nozzle moves toward the upper end once again after the discharging of the coating material from the slits of the coating nozzle on the rise is stopped and the movement of the coating nozzle to the upper end has been stopped once with the coating material transferred from the slits to the outer circumferential surface of the object.
